(19) United States
(12) Patent Application Publication
(10) Pub. No.: US 2024/0327062 A1
(43) Pub. Date: Oct. 3, 2024

(54) Carton with Integral Cover System

(71) Applicant: Blue Buffalo Enterprises, Inc., Wilton, CT (US)

(72) Inventors: Nicole Kandoth, Nyack, NY (US); Nicholas Kempfert, Minneapolis, MN (US); James E. McCay, Fairfield, CT (US)

(73) Assignee: Blue Buffalo Enterprises, Inc., Wilton, CT (US)

(21) Appl. No.: 18/681,540

(22) PCT Filed: Aug. 9, 2022
(86) PCT No.: PCT/US2022/039776

§ 371 Date: Feb. 6, 2024

Related U.S. Application Data
(60) Provisional application No. 63/239,560, filed on Sep. 1, 2021.

(51) Int. Cl. B65D 5/54; B65D 5/02; B65D 5/468; B65D 5/66; B65D 51/24; B65D 77/06

(52) U.S. Cl. CPC B65D 5/5425; B65D 5/0227; B65D 5/4608; B65D 5/6602; B65D 51/246; B65D 77/06

(57) ABSTRACT

A carton can be initially opened by pulling a gripping tab of a tear strip to detach of cover from the remaining body of the carton except along a hinge body portion on one side of the carton. With this arrangement, the carton can be opened by folding the cover back relative to the front panel along a hinge axis. Closing of the carton is performed by initially pivoting the cover such that a front portion of the cover extends about and overlaps a front panel portion of the carton. Then, the cover is pushed down, causing a portion of the hinge-defining strip to fold and the cover to shift downward so as to extend about and overlap portions of each of the sides of the carton.

### FIELD OF THE INVENTION

The invention generally pertains to packaging products, particular food products, in cartons and, more specifically, to a carton incorporating a cover system enabling the carton to not only be easy to initially open, but readily and repeatedly opened and closed in a convenient and effective manner throughout its useful life.

### BACKGROUND OF THE INVENTION

In connection with shipping products, such as food products, from a manufacturer to a retail establishment, it is known to package the products in a carton, seal the carton, and ship the carton for delivery to a designated retail establishment. Although various materials could be used in making the cartons, the most common material employed is paperboard. In general, the paperboard is provided in the form of a blank which can be conveniently stored in a flat configuration but easily erected through a simple folding operation to establish an open-ended carton which can be filled and sealed, typically in an automated process. These cartons are not only lightweight and quite strong, but the paperboard is advantageously recyclable.

In some situations, the cartons are designed with a closure system which enables the carton to be opened and closed numerous times prior to depleting the product therein. For example, it is widely known to package cereal and other food products in end load cartons and to provide the cartons with closure systems operating between upper and lower flaps of top portions of the cartons. In addition to end load cartons, top load cartons are popular for foods and other products. For example, donuts and other food products are often packaged in top load cartons, each including a cover which extends across an entire open top of the carton, with the cover being hinged to enable selective, repeated access to a product storage region of the carton.

Each of these known carton types has been employed in connection with storing and dispensing of animal food. Actually, there is a trend in the case of at least dry dog and cat foods to shift away from the large bags of food still found in many retail feed and grocery stores to carton containers. By way of example, it has previously been proposed to provide a carton with a reclosable top which can be opened to expose an internal bag within which dry pet food is stored. These storage cartons have many advantages over large bags of the food. In particular, with both the internal reclosing of the bag and the external closure of the carton, the ability to contain the odor of the food from exiting the carton and effectively keep animals out of the food between feedings are greatly enhanced. The cartons also advantageously provide storing advantages over large food bags as the cartons can be readily stacked with similar cartons or other packaged products, whereas the large pet food bags do not afford this benefit.

Even with the advantages mentioned above, there are certain drawbacks from known carton designs employed in the industry. For instance, the mechanisms employed for opening such cartons can be difficult to start. By way of example, it is known to provide a tear strip for use in at least partially detaching the cover of the carton. However, known tear strip arrangements, if not clearly marked, can be overlooked by consumers, resulting in the carton being opened in another manner with loss of the reclosing feature. In addition, even using the tear strip often leads to a carton being damaged to an extend which limits the ability to adequately cover the open portion of the carton between uses. If the damage includes larger strips of the carton being torn off, handles provided in sidewalls of the carton for carrying the same can be compromised. In any case, it is considered desirable to provide a food packaging and storing carton which addresses these and other drawbacks, particularly by providing an enhanced tear strip arrangement which is at least significantly less prone to tearing, avoids damage to any carton handles, and can be readily identified to assure the proper opening of the carton. In particular, it would be desirable to employ the tear strip to establish a cover for a carton wherein the cover can assume a closed position overlapping all side walls of the carton, thereby providing an enhanced closure arrangement. Furthermore, it is desired to provide a carton which is easy to breakdown after final use for recycling purposes.

### SUMMARY OF THE INVENTION

The invention is directed to a carton including a tear strip having opposing starter strip portions, each located in an upper rear panel portion of the carton and extending along perforated lines from the rear panel through side, front and opposing side panels of the carton. Once the tear strip is removed, a cover or lid is established which is only connected to the remainder of the carton through a hinge-defining strip extending along the rear panel of the carton. Given the positioning and size of the starter strip portions, the carton is torn around more than three sides, with the hinge-defining strip having a length less than the width of the rear panel. With this arrangement, the carton can be opened by folding the cover back relative to the front panel, with the initial folding establishing a flexible hinge axis. Closing of the carton is performed by initially pivoting the cover such that a front portion of the cover extends over and overlaps a front panel of the carton. Then, the cover is pushed down, causing a portion of the hinge-defining strip to fold and the cover to shift downward so as to extend about and overlap each of the sides of the carton.

Additional structural features are preferably provided to further enhance the closing operation. For instance, at front and/or rear corners of the carton, short vertical slits or cut-outs can be provided, starting from the tear line. With this enhancement, portions of the carton will readily deflect inward when the cover is extended over the panels and pushed downward. In establishing the hinge-defining strip, it has been found advantageous to provide the rear panel with at least one a line of perforations extending across the hinge-defining strip to enhance the establishment of the hinge axis. Furthermore, the hinge-defining strip is also preferably pre-formed with at least an intermediate fold line which aids in folding of the hinge-defining strip inward during the stage when the cover is pushed down.

As the invention is particularly designed for use in storing and dispensing of dry pet food, the carton also preferably incorporates other enhancements. For instance, the carton can include an internal bag in which the dry pet food is directly stored. The internal bag can be opening along a top seam and wrapped or otherwise sealed closed between uses to further prevent pet food odors emanating from the carton. In addition, one or more side carton handles can be provided to assist in carrying the carton, with each handle being formed as a full cut-out or by partially perforating a side portion of the carton which can be pivoted inward to enable fingers of the user to be inserted for lifting the carton. When provided, each handle is spaced well below the tear strip to ensure the integrity of the handle for selective use even after the carton is opened. Furthermore, the cover can itself include structure to support a removable utensil that can be conveniently used to scoop out measured portions of the dry pet food from within the bag housed in the carton.

Additional objects, features and advantages of the invention will become more readily apparent from the following detailed description when taken in conjunction with the drawings wherein like reference numerals refer to corresponding parts in the several views.

### BRIEF DESCRIPTION OF THE DRAWINGS

FIG. 1 is an upper perspective view of the carton constructed in accordance with the invention.

FIG. 2 is a lower perspective view of the carton of FIG. 1.

FIG. 3 is a plan view of a paperboard blank from which the carton of FIGS. 1 and 2 is erected.

FIG. 4 shows the carton of the invention during an initial opening stage.

FIG. 5 shows a tear strip of the carton in a partially torn state.

FIG. 6 shows the tear strip nearly fully removed from a remainder of the carton.

FIG. 7 shows a cover of the carton pivoted to an open condition.

FIG. 8 illustrates the mounting of a removable food scooping utensil to an inside cover portion of the carton.

FIG. 9 shows the cover of the carton pivoted to an initial closing condition.

FIG. 10 shows the cover of the carton pushed down to a fully closed condition.

### DETAILED DESCRIPTION OF INVENTION

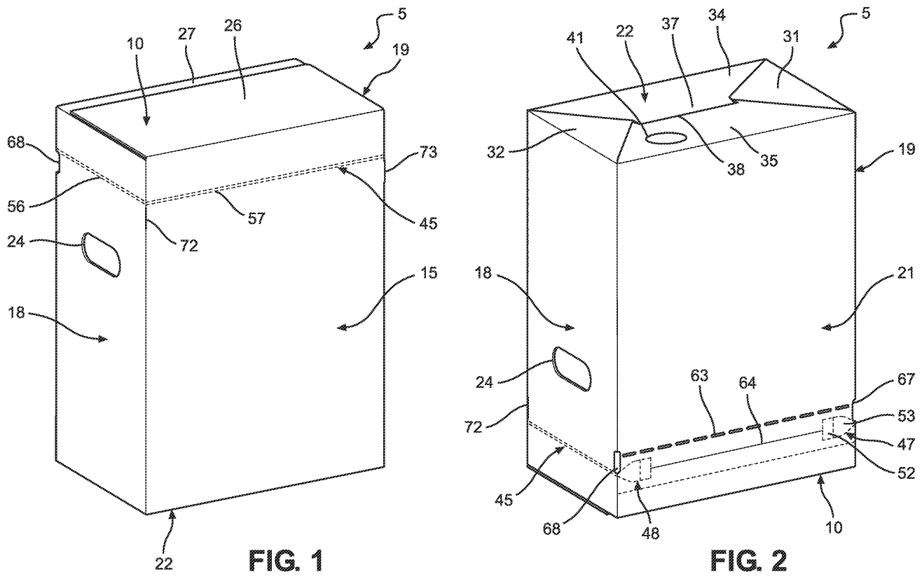

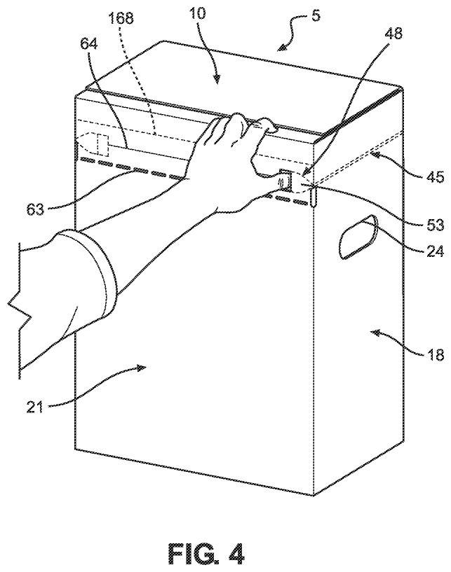

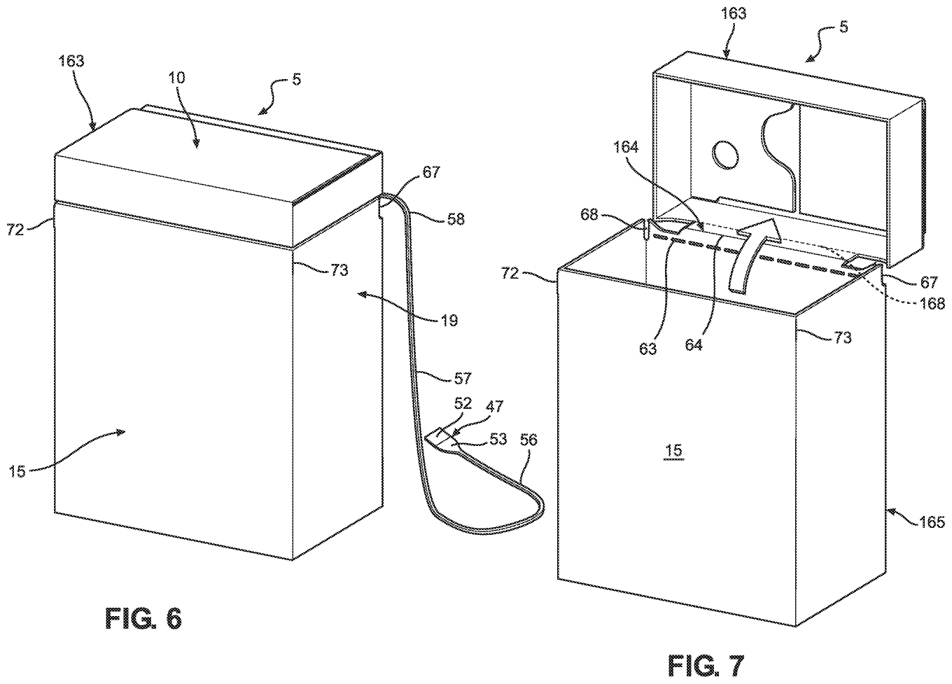

With initial reference to FIGS. 1 and 2, a carton constructed in accordance with the present invention is generally indicated at 5. Carton 5 includes a top 10, a front 15, sides 18 and 19, back 21 and a bottom 22. To assist in carrying carton 5, side 18 is formed with a cutout 24 defining a handle. As best shown in FIG. 1, top 10 is formed from an upper flap 26 which is adhesively secured to a lower flap 27. On the other hand, with particular reference to FIG. 2, bottom 22 includes in-folded side flaps 31 and 32, as well as interlocking main flaps 34 and 35. As will be detailed more fully below, main flap 34 includes a tongue member 37 which is received in a recessed portion 38 of main flap 35. As also shown, main flap 35 is provided with an enlarged opening 41 which, as will also be described more fully below, is provided to assist in readily breaking down carton 5 for recycling purposes. Carton 5 is also shown to include, spaced below top 10, a tear strip 45. In particular, tear strip 45 includes starter strip portions 47 and 48 provided at spaced locations in back 21. Each starter strip portion 47, 48 includes a finger deflecting tab 52 and a gripping tab 53 defining a respective terminal end of tear strip 45. As will be described more fully below in reference to FIGS. 4-6, finger deflecting tab 52 is meant to be punched out to enable a select one of gripping tabs 53 to be grabbed by a user in order to enable tear strip 45 to be removed, with tear strip 45 included a first side tear strip portion 56, a front side tear strip portion 57 and a second side tear strip portion 58 (FIG. 6 only). As best shown in FIG. 2, back 21 is pre-formed with a perforated hinge line 63, as well as a fold line 64, each of which is spaced from tear strip 45. In addition, carton 5 is provided with rear corner cutouts 67 and 68 extending between tear strip 45 and perforated hinge line 63 along portions of back 21 and sides 18 and 19 respectively. In a similar manner, front corner slits 72 and 73 extend down from tear strip 45 at the corners between front 15 and each of sides 18 and 19. At this point, it should be noted that the use of terms, such as upper, lower, inner, outer, front, rear, side and the like, is for reference purposes only in describing exemplary forms of the invention as set forth herein and illustrated in the drawings. Therefore, these terms should not be considered limiting as to the overall invention.

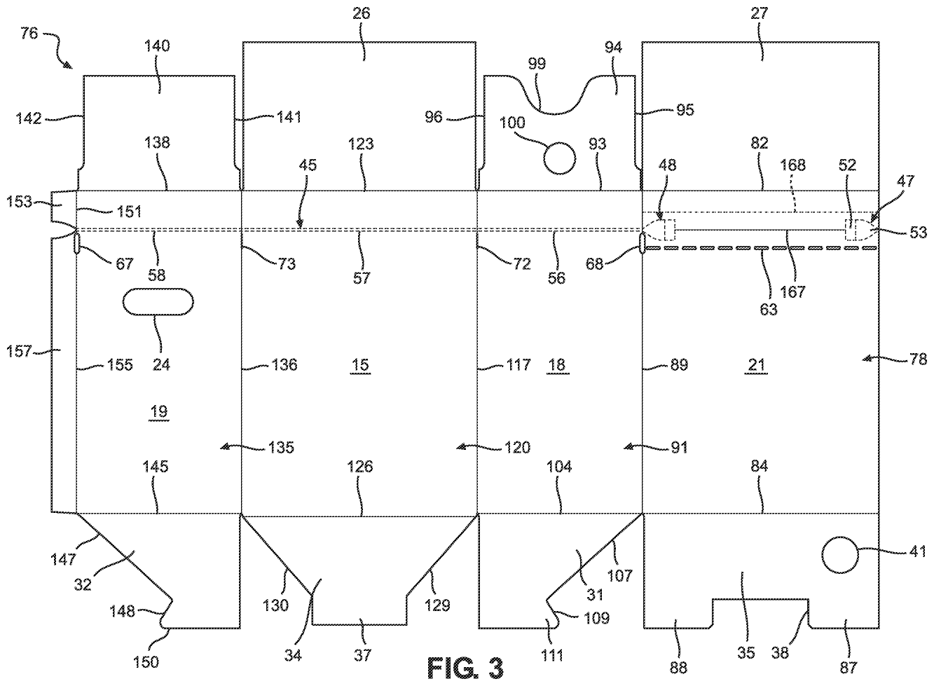

In accordance with a preferred embodiment, carton 5 is formed from a blank 76 as shown in FIG. 3. Blank 76 can be made from various materials, particularly cardboard which is widely known for use in the food industry for forming various types of food cartons. In any case, blank 76 is stamped from a single sheet to establish back 21 which is defined by a rear panel 78. Rear panel 78 includes an upper connecting fold line 82 leading to lower flap 27, as well as a lower connecting fold line 84 leading to interlocking main flap 35 of bottom 22. As shown, main flap 35 includes spaced extensions 87 and 88 extending on either side of recessed portion 38. Connected to rear panel 78 by a fold line 89 is a first side panel 91 defining side 18. First side panel 91 includes an upper connecting fold line 93 leading to a first inner flap 94. First inner flap 94 is shown to include tapered side sections 95 and 96, an upper central concave recess 99 and a hole 100 located between concave recess 99 and upper connecting fold line 93. First side panel 91 also has an associated lower connecting fold line 104 with in-folded side flap 31. In the embodiment shown, side flap 31 includes a first, inwardly extending angled side edge 107 leading to a second, outwardly extending angled side edge 109, which collectively establishes an interlocking tab 111.

First side panel 91 is connected along a fold line 117 to a front panel 120 defined by, in part, front 15. Front panel 120 has an associated upper connecting fold line 123 leading to upper flap 26 and a lower connecting fold line 126 leading to interlocking main flap 34. Main flap 34 is shown to include inwardly angled, opposing side edges 129 and 130 which lead to tongue member 37. Carton 5 also includes a second side panel 135 connected along a fold line 136 to front panel 120. Second side panel 135 has an upper connecting fold line 138 joining side 19 with a second inner flap 140 which, in a manner similar to inner flap 96 is provided with tapered side sections 141 and 142. Second side panel 135 is also connected to in-folded side flap 32 along a lower connecting fold line 145. In-folded side flap 32 is basically a mirror image of side flap 31 and therefore includes a first angled side edge 147 leading to a second angled side edge 148 in defining an interlocking tab 150. Finally, blank 76 includes a first fold line 151 between second side panel 135 and an upper attachment flap 153, as well as a second fold line 155 between second side panel 135 and a lower attachment flap 157. As shown, upper attachment flap 153 is located above tear strip 45, while lower attachment flap 157 is located below tear strip 45.

In assembling blank 76 of FIG. 3 into carton 5 of FIGS. 1 and 2, the various panels are folded along lines 89, 117, 136, 151 and 155, with upper attachment flap 153 and lower attachment flap 157 being secured to rear panel 78 with adhesive (not shown). Thereafter, in-folded side flaps 31 and 32 are folded along lower connecting fold line 104 and lower connecting fold line 145 respectively, with tabs 111 and 150 being interlocked. Thereafter, main flaps 34 and 35 are folded along lower connecting fold line 84 and lower connecting fold line 126 respectively, with tongue member 37 being inserted within recessed portion 38 to arrive at the assembled bottom 22 shown in FIG. 2. In closing off the remainder of carton 5, lower inner flap 94 is folded along upper connecting fold line 93, along with upper inner flap 140 being folded along upper connecting fold line 138. Finally, lower flap 27 is folded along upper connecting fold line 82 and then upper flap 26 is folded along upper connecting fold line 123 and glued to main flap 35 in order to form top 10 of carton 5 as shown in FIG. 1.

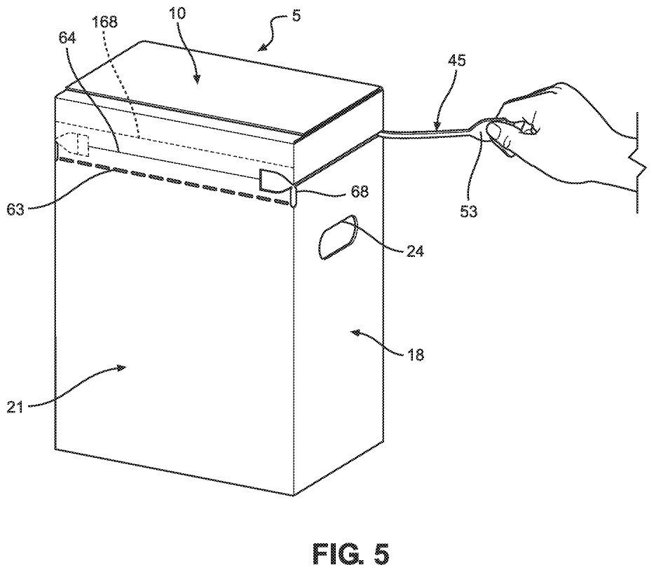

Reference will now be made to FIG. 4-6 in describing the manner in which carton 5 is opened. With initial reference to FIG. 4, a user has selected to insert a thumb to establish a hole at finger deflecting tab 52 of starter strip portion 48 which enables tab 53 to be readily grasped. As shown in FIG. 5, gripping tab 53 has been pulled such that tear strip 45 has extended completely across side 18. This pulling of gripping tab 53 continues as tear strip 45 is removed across front 15, side 19 and again to back 21 as represented in FIG. 6. With the detachment of starter strip portion 47, tear strip 45 is completely removed, thereby establishing a pivoting cover 163 for carton 5, with cover 163 being pivotable about perforated hinge line 63 of a hinge body portion 164 connecting cover 163 to a main body portion 165 of carton 5 as illustrated by the arrow in FIG. 7.

More specifically, cover 163 is formed from top 10 and upper sections (not separately labeled) of each of the front, rear, and opposing side panels 120, 78, 91 and 135, while being connected to a lower section of rear panel 78. At this point, it should be again noted that the terms like “front”, “rear” and “side” are only being used with reference to the embodiment depicted in the figures for use in explaining the invention. Therefore, by way of example, the carton could be rotated to make one side of the carton the “rear” for cover connecting purposes without departing from the invention. In any case, hinge body portion 164 defines a hinge axis along line 63, while also including at least one additional fold line 64 established by forming blank 76 with a crease during the stamping process. In the embodiment shown, fold line 64 is aligned with tear strip 45 and spaced from hinge axis 63. An additional fold line (not shown) could optionally be provide at a position further spaced from hinge axis 63. As will be detailed further below, the fold line(s) accommodates vertical shifting of cover 163.

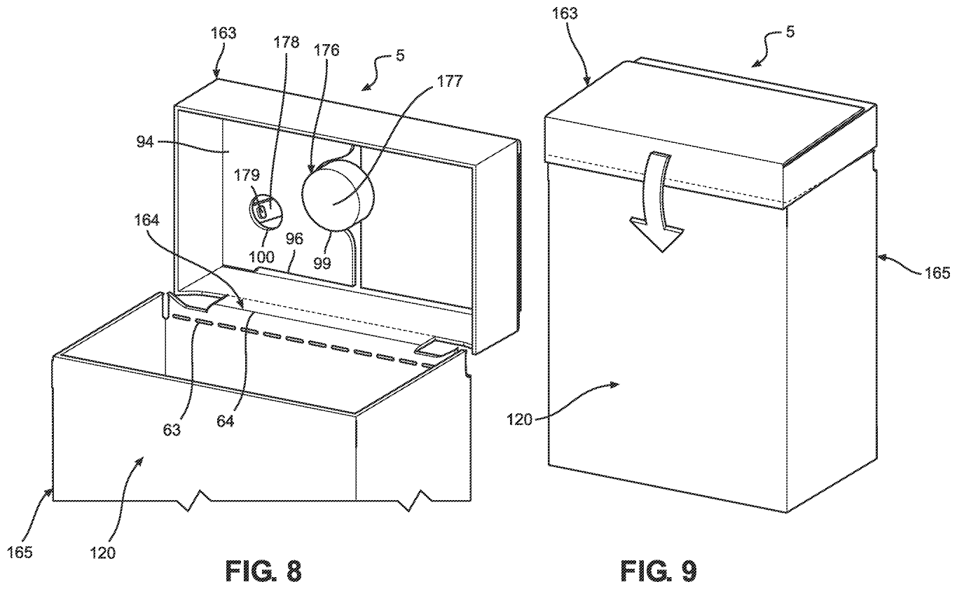

Prior to detailing the pivoting of cover 163, specific reference is made to FIG. 8 in describing additional aspects associated with the invention. Although carton 5 could be used for storing and accessing a wide range of product, the most preferred use for carton 5 is packaging dry pet food, particularly for dogs or cats. In one form, cartons 5 made in accordance with the invention can define 5-20 lb boxes for storing dry pet food which can be dispensed for feeding purposes over an extended period of time. In connection therewith, carton 5 may include a bag 172 containing the pet food, with the bag 172 being either rolled closed or otherwise sealed to retain odors, along with the closing of cover 163, between feedings. In addition, for use in measuring and dispensing the pet food, a utensil 176 is provided. More specifically, utensil 176 includes a scoop portion 177 and a handle portion 178 shown to include a through hole 179. For supporting utensil 176 between uses, cover 163 is advantageously designed with first inner flap 94 either frictionally fit or adhesively attached only along edges adjacent tapered side sections 95 and 96. This mounting arrangement establishes a pocket (not separately labeled), between flap 94 and lower flap 27, within which handle portion 178 can be slid. Given the presence of central concave recess 99, scoop portion 177 is snugly received. In addition, with the presence of hole 100, handle portion 178 is exposed to assist in maneuvering utensil 176 as needed.

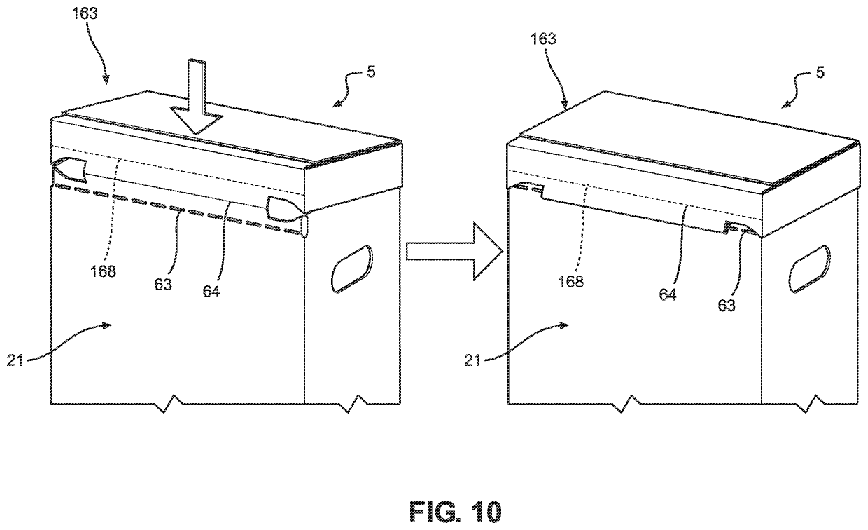

Reference will now be made to FIGS. 7, 9 and 10 in describing the manner in which cover 163 can be shifted between an opened position (FIG. 7), to a partially closed position (FIG. 9) and then to a fully closed position (FIG. 10). As discussed above, cover 163 can pivot about hinge axis 63 which is preferably established by a line of perforations formed in rear panel 78. In any case, it has been found that initially opening cover 163 by folding it back relative to front 15 establishes a readily flexible hinge axis. Closing of carton 5 is performed by initially pivoting cover 163 from the opened position of FIG. 7 to the partially closed position of FIG. 9 in which a front portion (not separately labeled) of cover 163 extends over and overlaps part of front panel 120. Then, a rear portion of cover 163 is pushed down, causing hinge body strip 164, constituting the only portion of carton 5 interconnecting cover 163 and main body portion 165, to fold along the one or more fold lines 63. This folding of the hinge-defining strip 182 enables cover 163 to shift downward so as to extend about and overlap each of sides 18 and 19 of carton 5, as well as even part of back 21. In addition, given the removal and size of starter strip portions 47 and 48, hinge body strip 182 has a length less than the width of rear panel 78 so there is no interference with this folding operation. Due to the nature of the material of blank 76, main body portion 165 can flex to some extent to accommodate this overlap. However, the inclusions of one or more of corner cut-outs 67, 68 and/or corner slits 72, 73 have been found to greatly enhance the ease in which cover 163 can be placed in the fully closed position, while also providing a more snug, retention fit to better seal carton 5 between uses. When the contents of carton 5 are depleted, enlarged opening 41 can be used to pull open interlocked bottom 22, with tongue 37 being removed from recess 38 and interlocking tbs 11 and 150 being pulled apart to enable blank 76 to readily assume a double layered, flat broken down posture, with cover 163 attached, for recycling purposes.

Based on the above, it should be readily apparent that the invention provides for a carton that is convenient to initially open, while establishing an advantageous, friction fit cover closure arrangement. In any case, although disclosed with reference to preferred embodiments of the invention, is should be readily apparent that various changes and modifications can be made to the invention without departing from the spirit thereof. Instead, the invention is only intended to be limited by the scope of the following claims.

1. A carton comprising:
a front panel;
a rear panel;
opposing side panels;
a bottom; and
a top, said top, along with upper sections of each of the front, rear and opposing side panels, defining a cover which is connected to one of the front, rear and opposing side panels by a hinge body portion, said hinge body portion defining a hinge axis and at least one fold line spaced from the hinge axis enabling the cover member to pivot about the hinge axis between an opened position, wherein an access opening to an interior of the carton is exposed, and a closed position, wherein the hinge body portion folds along the at least one fold line and the cover overlaps portions of at least each of the front and opposing side panels, and wherein one of the side panels includes an inner flap which is folded beneath a flap of the top, with both the inner flap and the flap of the top being part of the cover and, between the inner flap and the flap of the top, there is established a pocket.

2. The carton of claim 1, wherein the hinge axis is formed by a perforated line extending along an edge of the hinge body portion.

3. The carton of claim 2, wherein the perforated line extends along the rear panel.

4. The carton of claim 3, further comprising cuts provided at uppermost corner sections between the front panel and each of the opposing side panels.

5. The carton of claim 4, further comprising cut-outs provided at uppermost corner sections between the rear panel and each of the opposing side panels.

6. The carton of claim 1, wherein at least one of the opposing side portions is formed with a handle at a position spaced from the cover.

7. The carton of claim 1, further comprising a utensil at least partially stored within the pocket.

8. The carton of claim 7, wherein the utensil includes a scoop portion and a handle portion, with the handle portion being positioned in the pocket.

9. The carton of claim 7, wherein the inner flap includes a concave recess, said scoop portion nesting in the concave recess.

10. (canceled)

11. The carton of claim 1, further comprising a bag in the interior of the carton and dry pet food in the bag.

12. A carton comprising:
front, rear, bottom, top and opposing side panel portions;
a tear strip starting and ending in the rear panel at a position spaced below the top panel portion, said tear strip having terminal ends defined by starter strip portions formed in and spaced by a hinge body portion extending across the rear panel portion wherein, when the tear strip is removed entirely about the front and side panels to provide an access opening for the carton, a reusable, pivotable cover is established by upper sections of each of the front, rear, top and opposing side panel portions, and wherein one of the side panel portions includes an inner flap which is folded beneath a flap of the top panel portion, with both the inner flap and flap of the top panel portion being part of the cover and, between the inner flap and the flap of the top panel portion, there is established a pocket configured to hold a removable utensil.

13. The carton of claim 12, wherein each starter strip portion includes a deflecting tab and a gripping tab, with the deflecting tab being configured to be pivoted or poked out to establish an opening for grasping the gripping tab.

14. The carton of claim 12, wherein said rear panel portion includes a line of perforations establishing a hinge axis for the hinge body portion and said hinge body portion includes at least one fold line spaced from the hinge axis, with the cover being pivotable about the hinge axis between opened and partially closed positions.

15. The carton of claim 14, further comprising cuts or cut-outs in upper corners between the opposing side panel portions and each of the front and rear panel portions for enabling deflection of various ones of the front, rear and side panel portions upon shifting the cover from the partially closed position to a fully closed position.

16. The carton of claim 13, further comprising a bag in the interior of the carton and dry pet food in the bag.

17. A method of selectively opening and closing a cover of a carton including interconnected front, rear, bottom and opposing sides comprising:
opening the cover by pivoting the cover about a hinge axis of a hinge body portion to expose an access opening to an interior of the carton;
upon opening the cover, exposing a utensil stored in a pocket formed between two flaps of the cover; and
closing the cover by pivoting the cover about the hinge axis until a front portion of the cover extends about an upper portion of the front of the carton, then shifting a rear portion of the cover downward, causing the hinge body portion to fold, until the cover also extends about at least upper portions of each of the opposing sides.

18. The method of claim 17, further comprising, when closing the cover,
causing the cover to also extend about an upper portion of the rear side.

19. The method of claim 17, further comprising: deflecting at least one of the front and opposing sides when the cover is pivoted to extend about the upper portion of the front of the carton.

20. The method of claim 19, further comprising: deflecting at least one of the rear and opposing sides when the cover is shifted downward.

21. The method of claim 20, wherein the deflecting is assisted by providing slits or cutouts at corner portions between the opposing sides and each of the front and rear sides.
